(19) United States
(12) Patent Application Publication
(10) Pub. No.: US 2015/0373354 A1
(43) Pub. Date: Dec. 24, 2015

(54) METHOD AND DEVICE FOR ENCODING/DECODING IMAGE SO THAT IMAGE IS COMPATIBLE WITH MULTIPLE CODECS

(71) Applicant: SAMSUNG ELECTRONICS CO., LTD., Suwon-si Gyeonggi-do (KR)

(72) Inventors: Byeong-doo CHOI, Suwon-si (KR); Min-woo PARK, Hwaseong-si (KR); Yong-jin CHO, Seoul (KR); Jeong-hoon PARK, Seoul (KR); Jae-won YOON, Seoul (KR)

(73) Assignee: SAMSUNG ELECTRONICS CO., LTD., Suwon-si (KR)

(21) Appl. No.: 14/759,515

(22) PCT Filed: Jan. 7, 2014
(86) PCT No.: PCT/KR2014/000147

§ 371 Date: Jul. 7, 2015

Related U.S. Application Data
(60) Provisional application No. 61/749,472, filed on Jan. 7, 2013.

(51) Int. Cl. H04N 19/44; H04N 19/187

(52) U.S. Cl. CPC H04N 19/44; H04N 19/187

(57) ABSTRACT

An image decoding method including: determining whether image data of a base layer, which is encoded according to a first codec, is decodable according to a second codec; and decoding the image data of the base layer based on a result of the determining, wherein the image data includes image data of an enhancement layer, which is encoded according to the first codec.

### CROSS-REFERENCE TO RELATED APPLICATIONS

This application is a National Stage Application of International Patent Application No. PCT/KR2014/000147, filed on Jan. 7, 2014, which claims the benefit of U.S. Provisional Application No. 61/749,472, filed on Jan. 7, 2013, the disclosures of which are incorporated herein in their entirety by reference.

### BACKGROUND

1. Technical Field

Methods and apparatuses consistent with exemplary embodiments relate to a method and apparatus for encoding or decoding an image, and more particularly, to a method and apparatus for encoding or decoding an image compatible with a multi codec.

2. Description of Related Art

Along with the recent developments of digital display technologies and the advent of digital TVs having high resolution, a new codec for processing massive moving image data has been suggested.

However, an apparatus that is unable to support a new codec cannot decode image data that is encoded according to the new codec. Accordingly, a method of decoding the image data that is encoded according to the new codec may create a problem when used in an apparatus whereon the new codec has not been installed and where the apparatus is only capable of decoding an image according to an existing codec.

### SUMMARY

A technical goal of the exemplary embodiments may be is to provide a method and apparatus for decoding according to an existing codec image data that is encoded according to a new codec.

According to an exemplary embodiment, image data that is encoded according to a new codec may be decoded according to an existing codec.

According to an exemplary embodiment, it is easily determined whether image data encoded according to a new codec can be decoded according to an existing codec, and data required to decode the image data according to the existing codec may be selectively processed.

According to one or more exemplary embodiments, an image decoding method includes: determining whether image data of a base layer, which is encoded according to a first codec, is decodable according to a second codec; and decoding the image data of the base layer based on a result of the determining, wherein the image data comprises image data of an enhancement layer which is encoded according to the first codec.

The determining may include: obtaining a flag indicating whether the image data of the base layer, which is encoded according to the first codec, is decodable according to the second codec; and determining, according to a value of the flag, whether the image data of the base layer is decodable according to the second codec.

The decoding may include: obtaining compatibility information for decoding the image data of the base layer according to the second codec based on a result of the determining; and decoding the image data of the base layer according to the second codec by using the obtained compatibility information.

The decoding may include: determining image data to be decoded or to be received from an external device in order to decode the image data of the base layer according to the second codec by using the obtained compatibility information; and decoding the image data to be decoded or the image data received from the external device based on a result of the determining.

The decoding may include determining whether to decode the image data of the base layer according to the first codec or the second codec by using the obtained compatibility information.

According to one or more exemplary embodiments, an image encoding method includes: determining whether image data of a base layer, which is to be encoded according to a first codec, is decodable according to a second codec; and encoding, based on a result of the determining, the image data together with a bitstream in which an image of an enhancement layer is encoded according to the first codec.

The encoding may include: generating, based on a result of the determining, a flag indicating whether the image data of the base layer, which is to be encoded according to the first codec, is decodable according to the second codec; and inserting the flag into a predetermined region of the bitstream of the image data.

The encoding may include: obtaining compatibility information for decoding an image according to the second codec, based on a result of the determining; and inserting the obtained compatibility information into a predetermined region of the bitstream of the image data.

According to one or more exemplary embodiments, an image decoding apparatus includes: a compatibility determiner that determines whether image data of a base layer, which is encoded according to a first codec, is decodable according to a second codec; and an image decoder that decodes the image data of the base layer based on a result of the determination, wherein the image data includes image data of an enhancement layer, which is encoded according to the first codec.

According to one or more exemplary embodiments, an image encoding apparatus includes: a compatibility determiner that determines whether image data of a base layer, which is to be encoded according to a first codec, is decodable according to a second codec; and an image encoder that encodes the image data together with a bitstream in which an image of an enhancement layer is encoded according to the first codec, based on a result of the determination.

The first codec may be a new codec and the second codec may be an existing codec.

### DESCRIPTION OF THE DRAWINGS

FIG. 1 is a diagram illustrating an image processing environment compatible with a multi codec, according to an exemplary embodiment.

FIG. 2 is a diagram illustrating an example of hierarchical encoding or decoding according to an exemplary embodiment.

FIGS. 3 and 4 are block diagrams illustrating inner parts of an image encoding apparatus according to exemplary embodiments.

FIGS. 5 and 6 are block diagrams illustrating inner parts of an image decoding apparatus according to exemplary embodiments.

FIG. 7 is a block diagram illustrating an internal structure of an image encoder, according to an exemplary embodiment.

FIG. 8 is a block diagram illustrating an internal structure of an image decoder, according to an exemplary embodiment.

FIGS. 9 and 10 are flowcharts illustrating an image encoding method according to exemplary embodiments.

FIGS. 11 and 12 are flowcharts illustrating an image decoding method according to exemplary embodiments.

FIG. 13 is a diagram illustrating an example of a parameter set according to an exemplary embodiment.

### DETAILED DESCRIPTION

Hereinafter, exemplary embodiments will be described in detail with reference to accompanying drawings. In describing the exemplary embodiments, detailed descriptions about related well-known functions or configurations that may diminish the clarity of the points of the present invention are omitted. In the drawings, like reference numerals denote like elements.

The terms or words used in the present specification or claims described hereinafter should not be limitedly construed to the general or dictionary meanings, and should be construed as having meanings and concepts corresponding to technical aspects of the present invention based on the principle that an inventor may suitably define terms to describe the invention in the best way possible. Accordingly, one or more embodiments and configurations shown in drawings are only exemplary embodiments, and do not represent all technical aspects of the present invention. Thus, it should be understood that there may be various equivalents and changes capable of replacing the one or more exemplary embodiments.

Also, when a part “includes” or “comprises” an element, unless there is a particular description contrary thereto, the part can further include other elements, not excluding the other elements. In the following description, terms such as “unit” and “module” indicate a unit for processing at least one function or operation, wherein the unit and the block may be embodied as hardware or software or embodied by combining hardware and software.

One or more exemplary embodiments will now be described more fully with reference to the accompanying drawings. However, the one or more exemplary embodiments may be embodied in many different forms, and should not be construed as being limited to the embodiments set forth herein. In the following description, well-known functions or constructions are not described in detail since they would obscure the one or more exemplary embodiments with unnecessary details, and like reference numerals in the drawings denote like or similar elements throughout the specification

The principle of the present invention may be applied to arbitrary intra-frame and inter-frame-based encoding standards. The term “image” used throughout the specification is used not only as an “image” itself, but also as an inclusive term, such as a “frame”, a “field”, or a “slice”, for describing various forms of video image information, which are known in related fields.

Hereinafter, one or more exemplary embodiments will be described.

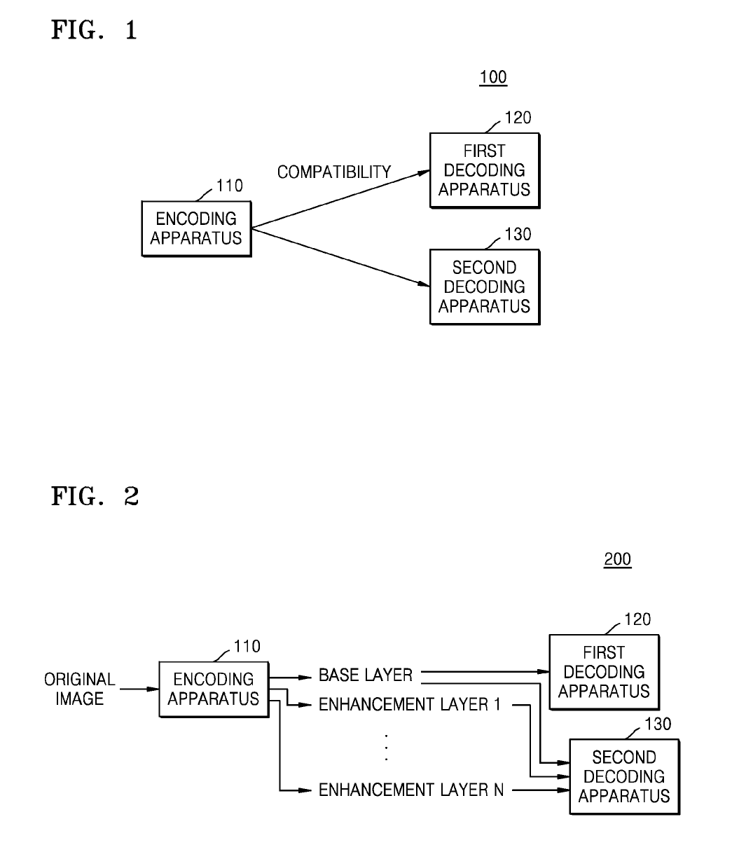

FIG. 1 is a diagram illustrating an image processing environment compatible with a multi codec, according to an exemplary embodiment.

Referring to FIG. 1, an image may be decoded as image data encoded by an encoding apparatus 100 is transmitted to a first decoding apparatus 120 or a second decoding apparatus 130 capable of decoding an image according to a new codec or an existing codec. According to an exemplary embodiment, image data encoded according to a new codec by the encoding apparatus 110 may also be decoded by the first decoding apparatus 120 capable of decoding an image according to an existing codec, and thus the image data may be compatible with both codecs.

The encoding apparatus 110 may encode an image according to a new codec and output a bitstream corresponding to a result of the encoding. An image codec is a unit for encoding or decoding a digital image, and the encoding apparatus 110 or the decoding apparatus 120 or 130 may encode or decode an image by using an image codec. A new codec is a codec for encoding or decoding an image by using an image of an enhancement layer, and may be, for example, a codec according to the high efficiency video coding (HEVC) standard. Also, an existing codec is a codec for encoding or decoding an image of a single layer, and may be, for example, a codec according to the H. 264 advanced video coding (AVC) standard.

Since image data encoded according to a new codec is encoded as an image of an enhancement layer, a decoding apparatus on which an existing codec is installed is unable to decode image data of an enhancement layer, and thus, cannot decode the image data encoded according to the new codec. However, if the decoding apparatus on which the existing codec is installed is able to selectively decode an image of a base layer from the image data encoded according to the new codec, the decoding apparatus may decode the image data encoded according to the new codec.

The encoding apparatus 110 according to an exemplary embodiment may encode an image according to a new codec, while outputting a bitstream into which a flag and compatibility information indicating that an image of a base layer is decodable according to an existing codec, is inserted.

The first decoding apparatus 120 is an image decoding apparatus capable of decoding an image according to the existing codec, and may determine whether an image of a base layer is decodable according to the existing codec based on the flag. When the image of the base layer of the image data encoded according to the new codec is decodable according to the existing codec, the first decoding apparatus 120 may decode the image by using the inserted compatibility information.

However, when the image of the base layer of the image data encoded according to the new codec cannot be decoded according to the existing codec, the first decoding apparatus 120 is unable to decode the image data.

The second decoding apparatus 130 is able to decode an image according to the new codec by using the new codec installed thereon. Moreover, when not only the new codec but also the existing codec are installed on the second decoding apparatus 130, the second decoding apparatus 130 may determine whether the image of the base layer is decodable according to the existing codec based on the flag. Accordingly, when the image of the base layer is decodable according to the existing codec, the second decoding apparatus 130 may decode the image of the base layer according to the existing codec and decode the image of the enhancement layer excluding the base layer according to the new codec by using the compatibility information.

FIG. 2 is a diagram illustrating an example of hierarchical encoding or decoding according to an exemplary embodiment.

Referring to FIG. 2, when the encoding apparatus 100 hierarchically encodes an image in N layers, the encoding apparatus 110 may output a scalable bitstream including a base layer bitstream, a first enhancement layer bitstream, a second enhancement layer bitstream, . . . , and an N-th enhancement layer bitstream. The first decoding apparatus 120 on which the existing codec is installed may selectively decode only the base layer bitstream from the scalable bitstream based on whether an image of a base layer is decodable according to the existing codec. Also, the second decoding apparatus 130 on which the new codec is installed may decode the scalable bitstream including the base layer bitstream and at least one enhancement layer bitstream.

The first decoding apparatus 120 may decode an image by selecting a bitstream of a base layer according to the existing codec by using compatibility information. Alternatively, the second decoding apparatus 130 may decode a base layer bitstream according to the existing codec and decode an enhancement layer bitstream according to the new codec based on whether an image of a base layer is decodable according to the existing codec.

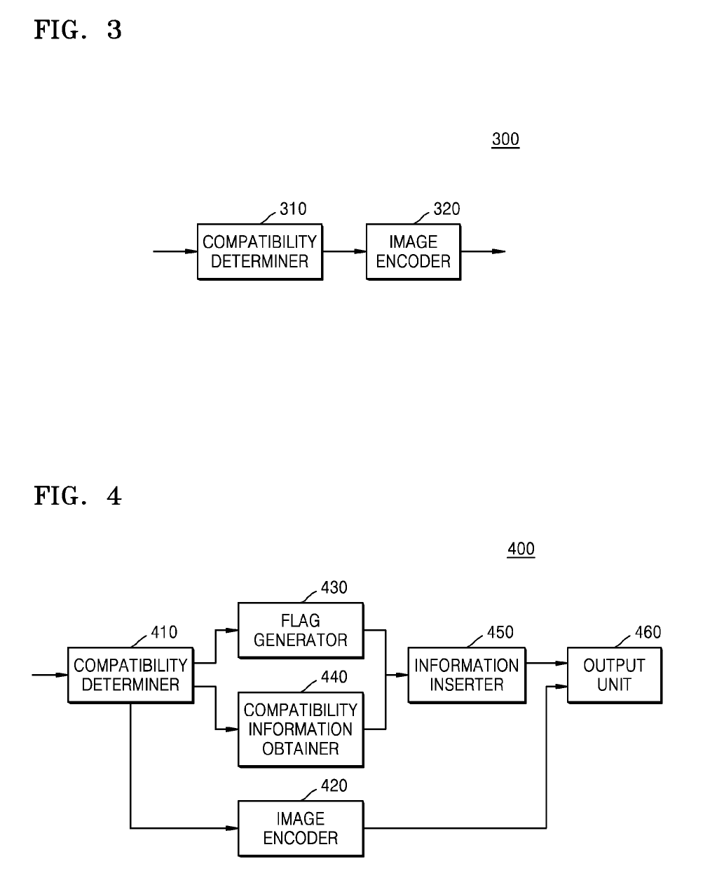

FIGS. 3 and 4 are block diagrams illustrating inner parts of an image encoding apparatus according to exemplary embodiments.

Referring to FIG. 3, an image encoding apparatus 300 may include a compatibility determiner 310 and an image encoder 320. However, not all illustrated components are essential components. The image encoding apparatus 300 may be realized by using more components than the illustrated components, or may be realized by using fewer components than the illustrated components.

Hereinafter, the above components will be sequentially described.

In the following description, a first codec and a second codec may respectively correspond to the new codec and the existing codec. However, alternatively, another type of image codec may be used.

The compatibility determiner 310 may determine whether a base layer bitstream of an image to be encoded according to the first codec is decodable according to the second codec.

The image encoder 320 may encode an image according to a result determined by the compatibility determiner 310, according to the first codec. In other words, the image encoder 320 may encode an image according to the first codec such that the base layer bitstream is decodable according to the second codec based on the result determined by the compatibility determiner 310.

Referring to FIG. 4, an image encoding apparatus 400 may include a compatibility determiner 410, an image encoder 420, a flag generator 430, a compatibility information obtainer 440, an information inserter 450, and an output unit 460. The compatibility determiner 410 and the image encoder 420 of FIG. 4 correspond to the compatibility determiner 310 and the image encoder 320 of FIG. 3, and overlapping descriptions are omitted. However, not all illustrated components are essential components. The image encoding apparatus 400 may be realized by using more components than the illustrated components or may be realized by using less components than the illustrated components.

Hereinafter, the above components will be sequentially described.

The compatibility determiner 410 may determine whether a base layer bitstream of an image to be encoded according to the first codec is decodable according to the second codec.

The image encoder 420 may encode the image according to the first codec, based on a result determined by the capability determiner 410. In other words, the image encoder 420 may encode an image of a plurality of enhancement layers according to the first codec, and a base layer bitstream is decoded according to the second codec based on the result determined by the compatibility determiner 410.

The flag generator 430 may generate a flag insertable into a bitstream based on the result determined by the compatibility determiner 410. A flag value generated at this time may have a value of 1 when the base layer bitstream is decodable according to the second codec, and may have a value of 0 when the base layer bitstream is not decodable according to the second codec, i.e., it is not compatible.

The compatibility information obtainer 440 may obtain compatibility information insertable into a bitstream based on the result determined by the compatibility determiner 410. The compatibility information may include information usable while decoding the base layer bitstream according to the second codec.

For example, the compatibility information may include level information or profile information of image data decodable according to the second codec. The level information may include information about a compression performance of encoded image data, and the profile information may include algorithm information required to encode or decode an image. The level information or the profile information is information required to decode an image, and an image decoding apparatus may determine whether the image is decodable by using the level information or the profile information.

The information inserter 450 may insert the flag generated by the flag generator 430 and the compatibility information obtained by the compatibility information obtainer 440 into a bitstream of image data to be encoded.

The output unit 460 may output the image encoded by the image encoder and a bitstream about information required to decode the image. The flag and the compatibility information insertable by the information inserter 450 are information required to decode the image, and thus may be inserted into the bitstream and output by the output unit 460.

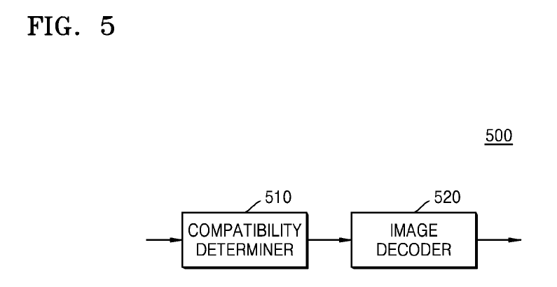

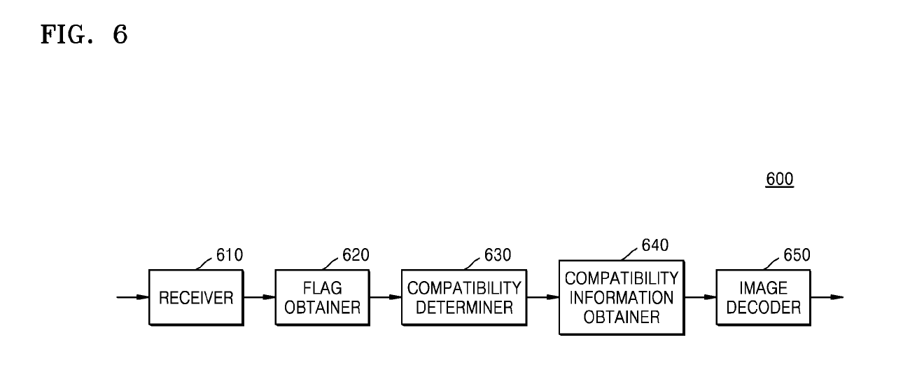

FIGS. 5 and 6 are block diagrams illustrating inner parts of an image decoding apparatus according to exemplary embodiments.

Referring to FIG. 5, an image decoding apparatus 500 may include a compatibility determiner 510 and an image decoder 520. However, not all illustrated components are essential components. The image decoding apparatus 500 may be realized by using more components than the illustrated components, or may be realized by using fewer components than the illustrated components.

Hereinafter, the above components will be sequentially described.

The compatibility determiner 510 may determine whether a base layer bitstream of an image encoded according to the first codec is decodable according to the second codec.

The image decoder 520 may decode an image of the base layer bitstream according to the second codec, based on a result determined by the compatibility determiner 510, i.e., based on compatibility with the second codec. For example, the image decoder 520 may decode the image of the base layer bitstream according to the second codec when decoded image data is compatible with the second codec. Moreover, when an image is decodable according to the first codec, the image decoder 520 may decode an image of an enhancement layer bitstream excluding the base layer bitstream according to the first codec.

Moreover, when the encoded image data is not compatible with the second codec, the image decoder 520 may decode a scalable bitstream including the base layer bitstream according to the first codec. However, if the image decoder 520 is not able to decode the image according to the first codec, the encoded image data is not compatible with the second codec, and thus the image decoding apparatus 500 may not decode the image data.

Referring to FIG. 6, an image decoding apparatus 600 may include a receiver 610, a flag obtainer 620, a compatibility determiner 630, a compatibility information obtainer 640, and an image decoder 650. The capability determiner 630 and the image decoder 650 of FIG. 6 correspond to the capability determiner 510 and the image decoder 520 of FIG. 5, and overlapping descriptions are omitted. However, not all illustrated components are essential components. The image decoding apparatus 600 may be realized by using more components than the illustrated components, or may be realized by using fewer components than the illustrated components.

Hereinafter, the above components will be sequentially described.

The receiver 610 may receive and parse a bitstream about an encoded image.

The flag obtainer 620 may obtain a flag for determining whether a bitstream of a base layer is decodable from the parsed bitstream according to the second codec. According to the flag value, it is determined whether a base layer bitstream of an encoded image is decodable according to the second codec. An obtainable flag value may have a value of 1 when the base layer bitstream is decodable according to the second codec, and may have a value of 0 when the base layer bitstream is not decodable according to the second codec, i.e., it is not compatible.

The compatibility determiner 630 may determine whether a base layer bitstream of an image encoded according to the first codec is decodable according to the second codec, based on a flag value obtained by the flag obtainer 620.

The capability information obtainer 640 may obtain compatibility information usable while decoding the base layer bitstream according to the second codec from the parsed bitstream, based on a result determined by the compatibility determiner 630 based on the flag value. As described above, the obtainable compatibility information may include level information and profile information.

The image decoding apparatus 600 according to an exemplary embodiment may use level information or profile information during a session negotiation or contents selection while decoding an image.

The session negotiation may include an operation of pre-determining data to be received from an external apparatus that transmits data, such that the image decoding apparatus 600 selectively receives data required to decode an image or data decodable by the image decoding apparatus 600. Here, the external apparatus is an apparatus that transmits encoded image data to the image decoding apparatus 600, and may be an image encoding apparatus or an apparatus storing encoded image data. For example, the image decoding apparatus 600 may selectively receive required image data or image data decodable by the image decoding apparatus 600 from the external apparatus, while the image decoding apparatus 600 decodes base layer image data according to the second codec by using compatibility information.

Accordingly, according to an exemplary embodiment, the image decoding apparatus 600 may perform the session negotiation by using the compatibility information. The flag and the compatibility information according to an exemplary embodiment may be obtained before the bitstream including the encoded image data, and thus the image decoding apparatus 600 may select image data to be received by using the compatibility information.

Moreover, the image decoding apparatus 600 may perform the contents selection by using the compatibility information. In other words, since the compatibility information includes profile information or level information of base layer image data encoded according to the second codec, the image decoding apparatus 600 may select image data required for decoding or decodable image data by using the compatibility information. For example, the image decoding apparatus 600 may select and decode the required image data or the decodable image data while the image decoding apparatus 600 decodes the base layer image data according to the second codec by using the compatibility information.

Accordingly, according to an exemplary embodiment, the image decoding apparatus 600 may perform the contents selection by using the compatibility information. The flag and the compatibility information according to an exemplary embodiment may be obtained before the bitstream including the encoded image data is received, and thus the image decoding apparatus 600 may select an image data portion to be encoded by using the compatibility information before the decoding. Then, the image decoding apparatus 600 may decode the selected image data by using the compatibility information.

The image decoder 650 may decode the image according to the flag value obtained by the flag obtainer 620 and the compatibility information obtained by the compatibility information obtainer 640. For example, when it is determined that the base layer bitstream is decodable according to the second codec based on the flag value, the image decoder 650 may decode the base layer bitstream according to the second codec by using the compatibility information. Alternatively, even when the base layer bitstream is decodable according to the second codec, the image decoder 650 may decode a scalable bitstream including the base layer bitstream according to the first codec. Also, when it is determined that the base layer bitstream is not decodable according to the second codec based on the flag value, the image decoder 650 may decode the scalable bitstream including the base layer bitstream according to the first codec.

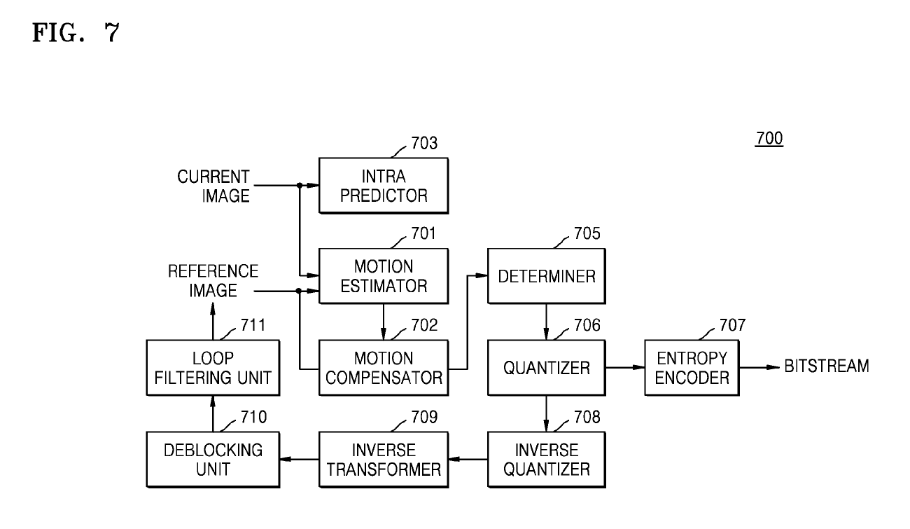

FIG. 7 is a block diagram illustrating an internal structure of an image encoder, according to an exemplary embodiment.

Referring to FIG. 7, an image encoder 700 according to an exemplary embodiment may include a motion estimator 701, a motion compensator 702, an intra predictor 703, a transformer 705, a quantizer 706, an entropy encoder 707, an inverse quantizer 708, an inverse transformer 709, a deblocking unit 710, and a loop filtering unit 711. The image encoder 700 of FIG. 7 may correspond to the image encoders 320 and 420 of FIGS. 3 and 4.

The motion estimator 701 may estimate motion of a current image that is an image currently externally input from among images forming a moving image by using reference images in a reference picture selection (RPS) of the current image.

The motion compensator 702 may generate a prediction image of the current image by using the reference images in the RPS of the current image. In detail, the motion compensator 702 may generate the prediction image of the current image by using the motion of the current image estimated by the motion estimator 701.

The intra predictor 703 may generate the prediction image of the current image by predicting each of the blocks corresponding to an intra mode from among blocks forming the current image.

The transformer 705 may transform a residual image calculated by subtracting the prediction image from the current image, from a spatial domain to a frequency domain. For example, the transformer 705 may transform the residual image from the spatial domain to the frequency domain by using integer transform of decimation-hadamard transform (DHT) or discrete cosine transform (DCT).

The quantizer 706 may quantize results transformed by the transformer 705.

The entropy encoder 707 may generate a bitstream by entropy encoding results quantized by the quantizer 706. In detail, the entropy encoder 707 may entropy encode information for decoding a moving image, for example, RPS information used for inter prediction, motion vector information, and location information of a neighboring block used for intra prediction, as well as the results quantized by the quantizer 706.

The inverse quantizer 708 may inverse-quantize the results quantized by the quantizer 706.

The inverse transformer 709 may restore the residual image of the current image and the prediction image by transforming results inverse-quantized by the inverse quantizer 708, i.e., transformation coefficient values, from a frequency domain to a spatial domain.

The deblocking unit 710 and the loop filtering unit 711 may adaptively perform filtering on an image restored by the inverse quantizer 708.

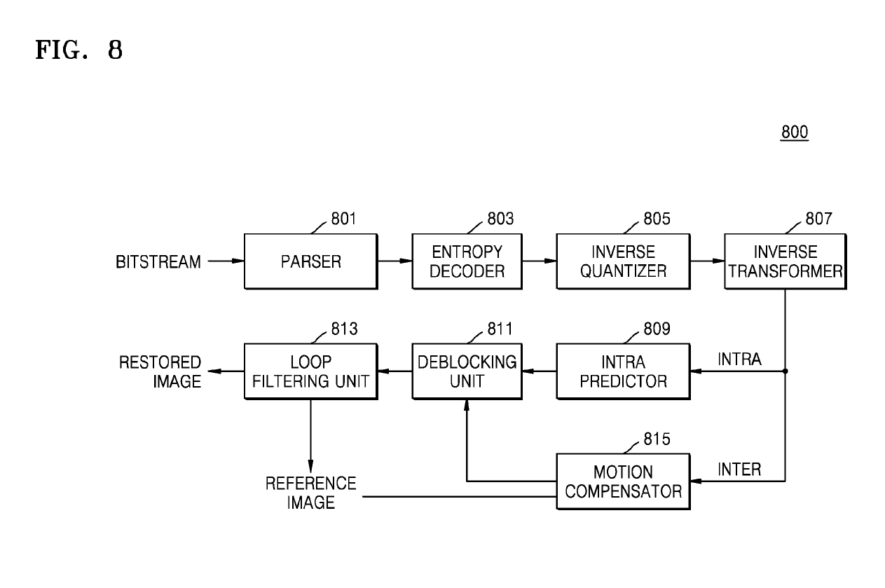

FIG. 8 is a block diagram illustrating an internal structure of an image decoder, according to an exemplary embodiment.

Referring to FIG. 8, an image decoder 800 according to an exemplary embodiment may include a parser 801, an entropy decoder 803, an inverse quantizer 805, an inverse transformer 807, an intra predictor 809, a motion compensator 815, a deblocking unit 811, and a loop filtering unit 813. The image decoder 800 of FIG. 8 may correspond to the image decoders 520 and 650 of FIGS. 5 and 6.

The parser 801 may parse encoded image data that is a decoding target and information about encoding that is required for decoding, from a bitstream.

The entropy decoder 803 may restore information for decoding a moving image by entropy-decoding the bitstream.

The inverse quantizer 805 may restore transformation coefficient values by inverse-quantizing values restored by the entropy decoder 803.

The inverse transformer 807 may restore a residual image of a current image and a prediction image by transforming the transformation coefficient values restored by the inverse quantizer 802 from a frequency domain to a spatial domain.

The intra predictor 809 may generate the prediction image of the current image by predicting a value of a block of the current image based on a value of a restored block neighboring the block of the current image from among blocks forming a restored current image with respect to each of the blocks corresponding to an intra mode, from blocks forming the current image. A restored image may be generated by adding the residual image to the prediction image.

The motion compensator 815 may generate the prediction image of the current image from reference images included in RPS used for prediction decoding of the current image. The restored image may be generated by adding the residual image to the prediction image.

The deblocking unit 811 and the loop filtering unit 813 may adaptively perform filtering on the restored image.

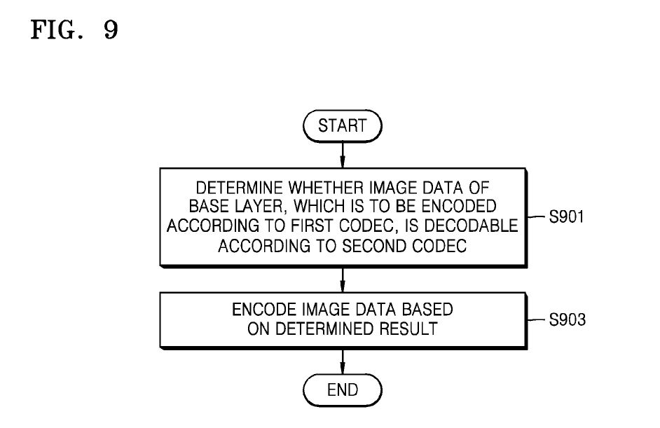

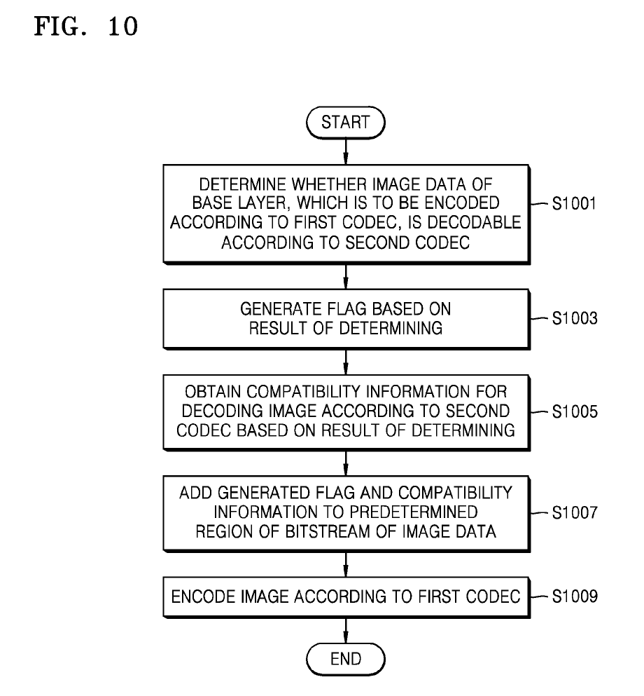

FIGS. 9 and 10 are flowcharts illustrating an image encoding method according to exemplary embodiments.

Referring to FIG. 9, in operation S901, the image encoding apparatus 300 may determine whether a base layer bitstream of an image to be encoded according to the first codec is decodable according to a second codec.

In operation S903, the image encoding apparatus 300 may encode image data based on a result determined in operation S901. In other words, the image encoding apparatus 300 may encode an image according to the first codec such that a base layer bitstream may be decoded according to the second codec based on the result determined in operation S901.

The method shown in FIG. 10 further includes inserting a flag and compatibility information into the bitstream, in addition to the method shown in FIG. 9. Operations S1001 and S1009 of FIG. 10 correspond to operations S901 and S903 of FIG. 9, and overlapping descriptions shall be omitted.

Referring to FIG. 10, in operation S1001, the image encoding apparatus 400 may determine whether a base layer bitstream of an image to be encoded according to the first codec is decodable according to the second codec.

In operation S1003, the image encoding apparatus 400 may generate a flag insertable into a bitstream of an image based on a result determined in operation S1001. A flag value generated at this time may have a value of 1 when the base layer bitstream is decodable according to the second codec, and may have a value of 0 when the base layer bitstream is not decodable according to the second codec, i.e., it is not compatible.

In operation S1005, the image encoding apparatus 400 may obtain compatibility information insertable into the bitstream based on the result determined in operation S1001. The compatibility information may include information used when the base layer bitstream is decoded according to the second codec, and for example, may include level information or profile information of the image data.

In operation S1007, the image encoding apparatus 400 may add the flag and the compatibility information generated in operations S1003 and S1005 to a predetermined region of the bitstream of the image data. In other words, the image encoding apparatus 400 may add the flag and the compatibility information to the predetermined region of the bitstream of the image data encoded according to the first codec.

When it is determined that the base layer bitstream is decodable according to the second codec in operation S1001, the bitstream of the image data encoded according to the first codec may be encoded such that the base layer bitstream is also decodable according to the second codec.

Moreover, when it is determined that the base layer bitstream is not decodable according to the second codec in operation S1001, the bitstream of the image data encoded according to the first codec may be encoded without considering the second codec.

In operation S1009, the image encoding apparatus 400 may encode the image data according to the first codec based on the result determined in operation S1001. In other words, when it is determined that the base layer bitstream to be encoded is decodable according to the second codec in operation S1001, the image encoding apparatus 400 may encode the image data such that the base layer bitstream is decodable not only according to the first codec but also according to the second codec. Alternatively, the image encoding apparatus 400 may encode the image data such that the base layer bitstream is decodable according to the second codec.

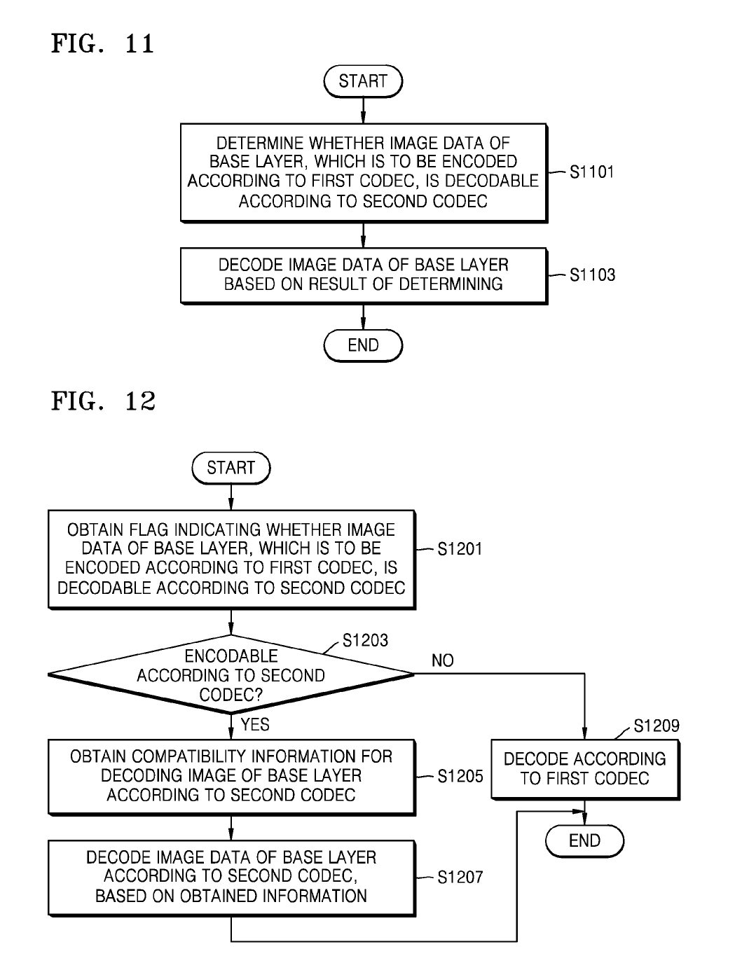

FIGS. 11 and 12 are flowcharts illustrating an image decoding method according to exemplary embodiments.

Referring to FIG. 11, in operation S1101, the image decoding apparatus 500 may determine whether a base layer bitstream of an image encoded according to the first codec is decodable according to the second codec.

In operation S1103, the image decoding apparatus 500 may decode the base layer bitstream based on a result determined in operation S1101. In other words, the image decoding apparatus 500 may decode the base layer bitstream according to the second codec, based on the result determined in operation S1101.

The method shown in FIG. 12 further includes obtaining a flag and compatibility information inserted into a bitstream, in addition to the method shown in FIG. 11. Operation S1201 and S1207 of FIG. 12 correspond to operations S1101 and S1103 of FIG. 11, and thus overlapping descriptions are omitted.

Referring to FIG. 12, in operation S1201, the image decoding apparatus 600 may obtain a flag for determining whether a bitstream of a base layer is decodable according to the second codec, from a bitstream related to an encoded image, which is received and parsed. The parsed bitstream may be a bitstream of an image encoded according to the first codec.

An obtainable flag value may have a value of 1 when the base layer bitstream is decodable according to the second codec, and may have a value of 0 when the base layer bitstream is not decodable according to the second codec, i.e., it is not compatible.

In operation S1203, the image decoding apparatus 600 may determine whether the base layer bitstream is decodable according to the second codec based on the flag value obtained in operation S1201.

When the base layer bitstream is decodable according to the second codec, the image decoding apparatus 600 may obtain compatibility information for decoding the image of the base layer according to the second codec in operation S1205.

In operation S1207, the image decoding apparatus 600 may decode the image data according to the first codec while decoding the image data of the base layer according to the second codec based on the compatibility information obtained in operation S1205. For example, as described above, the image decoding apparatus 600 may select image data required to decode the image data of the base layer according to the second codec, or decodable image data, by using the compatibility information. The image decoding apparatus 600 may receive the selected image data from an external apparatus, or may process and decode only the selected image data.

The image decoding apparatus 600 may decode base layer image data according to the first codec without being limited to the above method, even when the base layer image data (bitstream) is decodable according to the second codec. For example, the image decoding apparatus 600 may determine whether decoding the base layer image data according to the second codec based on the compatibility information or other information usable while decoding the image data is more efficient than decoding according to the first codec. The image decoding apparatus 600 may decode the image data according to the result of determining or may decode the base layer image data according to the second codec or the first codec based on a user input or a pre-set matter.

When it is determined that the base layer bitstream is not decodable according to the second codec in operation S1203, the image decoding apparatus 600 may decode the base layer bitstream according to the first codec in operation S1209. Meanwhile, when the image decoding apparatus 600 is unable to decode the image data according to the first codec, the corresponding image data may not be decoded.

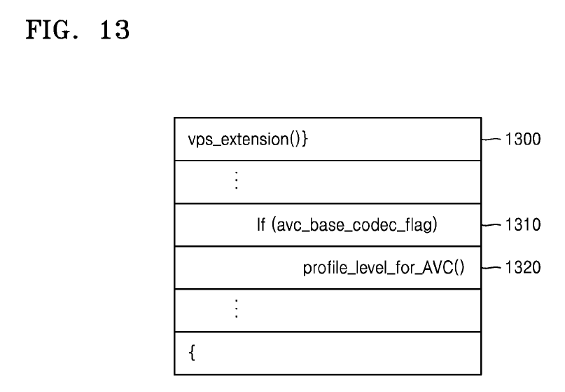

FIG. 13 is a diagram illustrating an example of a parameter set according to an exemplary embodiment.

Referring to FIG. 13, vps_extension 1300 may include avc_base_codec_flag and profile_level_for_AVC( ).

vps_extension 1300 is an extended parameter set of vps, and a flag and compatibility information according to an exemplary embodiment may be inserted into a region of vps_extension 1300 of a bitstream. In other words, avc_base_codec_flag and profile_level_for_AVC( ) of FIG. 13 are syntaxes respectively corresponding to the flag and the compatibility information according to an exemplary embodiment.

avc_base_codec_flag may have a value of 0 or 1 based on whether a base layer bitstream is decodable according to the second codec, for example, an AVC codec.

Accordingly, when a flag value is 1 in if(avc_base_codec_flag) 1310, i.e., when the base layer bitstream is decodable according to the second codec, the image decoding apparatus 600 may obtain the compatibility information according to a syntax of profile_level_for_AVC 1320. Accordingly, the image decoding apparatus 600 may decode the base layer bitstream according to the second codec, by using the obtained compatibility information.

According to an exemplary embodiment, image data encoded according to a new codec may be decoded according to an existing codec.

According to an exemplary embodiment, it is easily determined whether image data encoded according to a new codec is decodable according to an existing codec, and only data required during decoding according to the existing codec may be processed.

The exemplary embodiments of the present invention can also be implemented as computer (including all information processable devices)-readable code on a computer-readable recording medium. The computer-readable recording medium is any data storage device that can store data which can be thereafter read by a computer system. Examples of the computer-readable recording medium include ROM, RAM) CD-ROMs, magnetic tapes, floppy disks, and optical data storage devices.

While exemplary embodiments have been particularly described with reference to novel features applied to various embodiments, it will be understood by those of ordinary skill in the art that various eliminations, replacements, and changes in form and details may be made therein without departing from the spirit and scope of the present invention. Thus, the scope of the present invention is defined by the following claims, rather than the above description. All changes within the equivalent scope of the claims are included in the scope of the present invention.

1. An image decoding method comprising:
determining whether image data of a base layer, which is encoded according to a first codec, is decodable according to a second codec; and
decoding the image data of the base layer based on a result of the determining,
wherein the image data comprises image data of an enhancement layer which is encoded according to the first codec.

2. The image decoding method of claim 1, wherein the determining comprises:
obtaining a flag indicating whether the image data of the base layer, which is encoded according to the first codec, is decodable according to the second codec; and
determining, according to a value of the flag, whether the image data of the base layer is decodable according to the second codec.

3. The image decoding method of claim 1, wherein the decoding comprises:
obtaining compatibility information for decoding the image data of the base layer according to the second codec based on a result of the determining; and
decoding the image data of the base layer according to the second codec by using the obtained compatibility information.

4. The image decoding method of claim 3, wherein the decoding comprises:
determining image data to be decoded or to be received from an external device in order to decode the image data of the base layer according to the second codec by using the obtained compatibility information; and
decoding the image data to be decoded or the image data received from the external device based on a result of the determining.

5. The image decoding method of claim 3, wherein the decoding comprises determining whether to decode the image data of the base layer according to the first codec or the second codec by using the obtained compatibility information.

6. An image encoding method comprising:
determining whether image data of a base layer, which is to be encoded according to a first codec, is decodable according to a second codec; and
encoding, based on a result of the determining, the image data together with a bitstream in which an image of an enhancement layer is encoded according to the first codec.

7. The image data encoding method of claim 6, wherein the encoding comprises:
generating, based on a result of the determining, a flag indicating whether the image data of the base layer, which is to be encoded according to the first codec, is decodable according to the second codec; and
inserting the flag into a predetermined region of the bitstream of the image data.

8. The image data encoding method of claim 6, wherein the encoding comprises:
obtaining compatibility information for decoding an image according to the second codec, based on a result of the determining; and
inserting the obtained compatibility information into a predetermined region of the bitstream of the image data.

9. An image decoding apparatus comprising:
a compatibility determiner that determines whether image data of a base layer, which is encoded according to a first codec, is decodable according to a second codec; and
an image decoder that decodes the image data of the base layer based on a result of the determination,
wherein the image data comprises image data of an enhancement layer, which is encoded according to the first codec.

10. The image decoding apparatus of claim 9, further comprising a flag obtainer that obtains a flag indicating whether the image data of the base layer, which is encoded according to the first codec, is decodable according to the second codec,
wherein the compatibility determiner determines whether the image data of the base layer is decodable according to the second codec according to a value of the flag.

11. The image decoding apparatus of claim 9, further comprising a compatibility information obtainer that obtains compatibility information for decoding the image data of the base layer according to the second codec, based on a result of the determination,
wherein the image decoder decodes the image data of the base layer according to the second codec by using the obtained compatibility information.

12. The image decoding apparatus of claim 11, wherein the image decoder determines, by using the obtained compatibility information, image data to be decoded or to be received from an external device in order to decode the image data of the base layer according to the second codec, and decodes the image data or receives the image data from the external device according to a result of the determination.

13. An image encoding apparatus comprising:
a compatibility determiner that determines whether image data of a base layer, which is to be encoded according to a first codec, is decodable according to a second codec; and
an image encoder that encodes the image data together with a bitstream in which an image of an enhancement layer is encoded according to the first codec, based on a result of the determination.

14. The image encoding apparatus of claim 13, further comprising:
a flag generator that generates a flag indicating whether image data of a base layer, which is to be encoded according to a first codec, is decodable according to the second codec, based on a result of the determination; and
an information inserter that inserts the flag into a predetermined region of the bitstream of the image data.

15. The image encoding apparatus of claim 13, further comprising a compatibility information obtainer that obtains compatibility information for decoding an image according to the second codec, based on a result of the determination,
wherein the information inserter inserts the obtained compatibility information into a predetermined region of the bitstream of the image data.

16. The image decoding method according to claim 1, wherein the first codec is a new codec and the second codec is an existing codec.

17. The image encoding method according to claim 6, wherein the first codec is a new codec and the second codec is an existing codec.

18. The image decoding apparatus according to claim 9, wherein the first codec is a new codec and the second codec is an existing codec.

19. The image encoding apparatus according to claim 13, wherein the first codec is a new codec and the second codec is an existing codec.
